(19) United States
(12) Patent Application Publication
(10) Pub. No.: US 2025/0182257 A1
(43) Pub. Date: Jun. 5, 2025

(54) METHOD FOR MAKING AN IMAGE OF AN INDIVIDUAL COMPLIANT WITH A STANDARD

(71) Applicant: IDEMIA IDENTITY & SECURITY FRANCE, Courbevoie (FR)

(72) Inventors: Christelle BAUDRY, Courbevoie (FR); Stéphane GENTRIC, Courbevoie (FR)

(73) Assignee: IDEMIA IDENTITY & SECURITY FRANCE, Courbevoie (FR)

(21) Appl. No.: 18/842,085

(22) PCT Filed: Jan. 23, 2023
(86) PCT No.: PCT/EP2023/051590

§ 371 Date: Aug. 28, 2024

(30) Foreign Application Priority Data
Mar. 15, 2022 (FR) FR2202261

(51) Int. Cl. G06T 7/00; G06T 11/60; G06V 10/74; G06V 10/82; G06V 40/16

(52) U.S. Cl. CPC G06T 7/0002; G06T 11/60; G06V 10/74; G06V 10/82; G06V 40/168; G06V 40/172; G06T 2207/20084; G06T 2207/30201

(57) ABSTRACT

A method for making an image of an individual, being an intermediate image, compliant with a standard, including extracting first biometric data of the individual, determining first data relating to the standard, and modifying the intermediate image into a modified image by way of a generative adversarial network, checking the compliance of the modified image, verifying the integrity of the biometric identity, validating the modified image if the biometric identity exhibits integrity and the modified image is determined to be compliant, and reiterating the modified image from the previous iteration as intermediate image.

### TECHNICAL FIELD

The invention relates to the field of artificial intelligence and generative adversarial networks for modifying images.

### PRIOR ART

It is known from the prior art to use generative adversarial networks to modify an image comprising a face so as to modify a physical characteristic of said face. For example, it is known from these techniques to modify a facial expression or to remove an accessory from or to add an accessory to said face. It is sometimes verified that the modification is realistic, that is to say that the modified face still appears to be that of the same person. The main geometric characteristics of the face are preserved.

The problem with these techniques known from the prior art is that they do not guarantee the integrity of the biometric characteristics of a person. Even if the modification does not appear to have modified the face of the person, a biometric device might no longer recognize the biometric identity of the person after the image has been modified.

Modifying a face on an identity photo using a technique from the prior art, in order to make it compliant with a standard, might thus affect the biometric characteristics of said face.

The invention aims to solve the abovementioned problems of the prior art by proposing a method for making an image of an individual compliant with a standard, guaranteeing the integrity of biometric and physical characteristics of said individual.

### SUMMARY OF THE INVENTION

The invention relates to a method for making an image of an individual, referred to as an intermediate image, compliant with a standard using a computer, the compliance method comprising a first extraction step of extracting first biometric data of the individual from the image of the individual, a first determination step of determining first data relating to the standard based on the image of the individual, and a processing step comprising:
a step of modifying the intermediate image into a modified image by way of a generative adversarial network,
a second determination step of determining second data relating to the standard, based on the modified image,
a step of checking the compliance of the modified image with the standard based on the second data relating to the standard, the modified image being determined to be compliant or non-compliant,
a second extraction step of extracting second biometric data of the individual from the modified image,
a step of verifying the integrity of the biometric identity by comparing the first biometric data with the second biometric data, the compliance method comprising a step of validating the modified image if the biometric identity exhibits integrity and the modified image is determined to be compliant, the modified image being a final image, the compliance method otherwise comprising the processing step reiterated with the modified image from the previous iteration as intermediate image.

According to one aspect of the invention, the compliance method furthermore comprises a first characterization step that generates first data relating to physical attributes based on the image of the individual, the processing step comprising a second characterization step that generates second data relating to physical attributes based on the modified image, the verification step furthermore comprising verifying the integrity of the physical attributes by comparing the first data relating to the physical attributes with the second data relating to the physical attributes, the modified image being validated in the validation step if the physical attributes also exhibit integrity, the processing step being reiterated otherwise.

According to one aspect of the invention, the image of the individual comprises a face, the physical attributes comprising accessories such as glasses, a sanitary mask, and personal attributes such as a mustache, a beard, a mark on the skin, a characteristic relating to hair, an age, a gender.

According to one aspect of the invention, the generative adversarial network comprises a latent space containing a plurality of data points, each data point being associated with an image, the intermediate image being represented by a data point whose position in the latent space is a function of biometric and physical characteristics of the individual and of characteristics relating to the standard, the intermediate image being modified by a displacement in the latent space as a function of the first biometric data of the individual and the first data relating to the standard.

According to one aspect of the invention, the displacement minimizes a deviation between current parameters comprising the biometric characteristics and the characteristics relating to the standard corresponding to the data point associated with the intermediate image, and target parameters comprising target biometric characteristics corresponding to the first biometric data and target characteristics relating to the standard and compliant with the standard.

According to one aspect of the invention, the current parameters furthermore comprise the physical characteristics corresponding to the data point associated with the intermediate image and the target parameters furthermore comprise target physical characteristics corresponding to the first data relating to the physical attributes.

According to one aspect of the invention, the image of the individual comprises a face of said individual, the standard relating to identity photographs intended to be affixed to identity documents, for example as specified by the ICAO.

According to one aspect of the invention, the standard comprises at least one criterion from among a facial pose, a facial expression, an image background, opening of a mouth or an eye, a gaze orientation, a position of an accessory such as glasses, illumination of the face.

According to one aspect of the invention, the image of the individual is a photograph acquired by a device allowing access to an access-controlled area.

According to one aspect of the invention, the image of the individual is a photograph acquired by a mobile device.

The invention also relates to a computer program product comprising program instructions implementing the steps of the compliance method when the program instructions are executed by a computer.

The invention also relates to a processing unit comprising a neural network comprising a generative adversarial network and a computer, the computer being configured to make an image of an individual compliant with a standard using the compliance method.

### BRIEF DESCRIPTION OF THE DRAWINGS

Other advantages and features of the invention will become apparent on reading the description and the drawings.

FIG. 1 illustrates a generative adversarial network comprising a latent space.

FIG. 2 illustrates a representation of the latent space.

FIG. 3 illustrates a plurality of data points within the latent space.

FIG. 4a illustrates the steps of the method of the invention, said steps comprising a processing step.

FIG. 4b illustrates the various steps of the processing step.

FIG. 5 illustrates a neural system comprising a computer, generating first data associated with an image of an individual.

FIG. 6 illustrates the neural system generating adjusted first data based on a data point representing the image of the individual in a latent space.

FIG. 7 illustrates the neural system modifying an intermediate image by way of a displacement in the latent space.

FIG. 8 illustrates the neural system generating second data based on a modified image.

### DESCRIPTION OF EMBODIMENTS

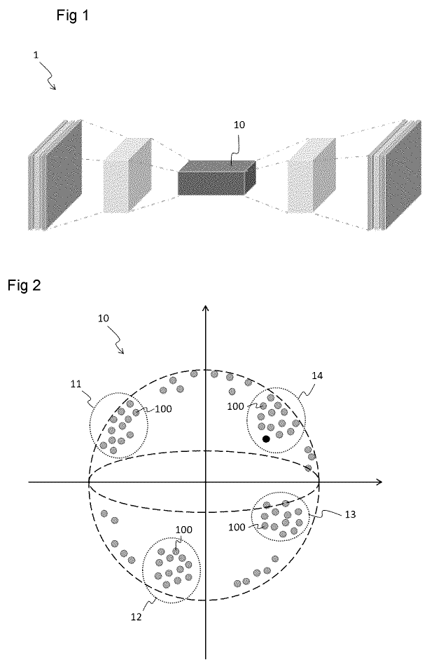

FIG. 1 illustrates an assembly comprising a neural network 2 and a generative adversarial network 1 comprising a latent space 10.

Such a system is able to modify an intermediate image relating to an individual into a modified image by way of the generative adversarial network 1. An intermediate image is understood to mean an image that is not compliant with a predetermined standard and that therefore has to be modified to be compliant with said standard.

An intermediate image is for example an image of an individual acquired by an image-capturing device.

The image-capturing device is for example a device allowing access to an access-controlled area.

The image-capturing device is for example a mobile device such as a telephone, a tablet, a laptop or a watch.

An intermediate image is for example an image derived from an image of an individual that has already been modified but that is still not compliant with the standard.

FIG. 2 illustrates a representation of the latent space 10.

The latent space 10 contains a plurality of data points derived from vectors generated by the neural network 2, based on an image library.

A data point is associated with an image.

An image relating to an individual is represented in the latent space 10 by a data point 100.

The position of a data point 100 in the latent space 10 is a function of biometric and physical characteristics of the individual and of criteria relating to the standard.

The data points 100 are grouped into data clusters 11, 12, 13, 14. Each data cluster 11, 12, 13, 14 is associated with a biometric identity of an individual.

A data cluster 11, 12, 13, 14 may be more or less well defined or broad depending on the biometric identity of the individual.

Thus, within a data cluster 11, 12, 13, 14, the biometric identity of the individual is the same, but the physical characteristics of the individual and the criteria relating to the standard may vary.

A displacement within a data cluster 11, 12, 13, 14 in the latent space 10 makes it possible to generate, via the associated generative adversarial network 1, a modified image that guarantees that the biometric identity of an individual will be preserved, but modifies physical characteristics of the individual and/or criteria relating to the standard.

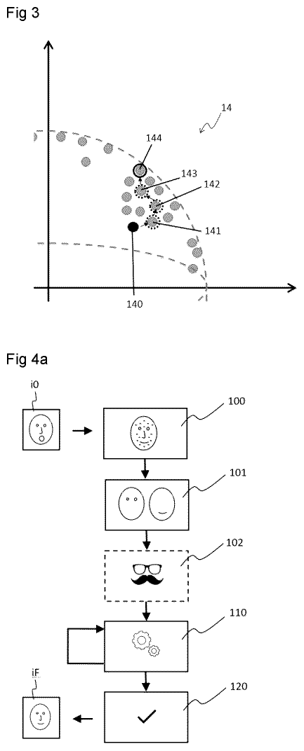

FIG. 3 illustrates a displacement within a data cluster 14, from an initial data point 140 to a final data point 144, passing via intermediate data points 141, 142, 143.

For example, the image of an individual acquired by an image-capturing device corresponds to the initial data point 140.

The successive displacements to the intermediate data points 141, 142, 143 and the final data point 144 make it possible to generate modified images that guarantee the integrity of the biometric identity of the individual.

For example, the image of an individual is an identity photo comprising the face of said individual.

For example, the standard relates to identity photographs intended to be affixed to identity documents, in particular as specified by the ICAO.

Using the generative adversarial network 1, a computer is able to modify an identity photo of an individual not compliant with the ICAO standard into an identity photo compliant with the ICAO standard, while preserving the biometric identity of the individual, through successive displacements within the latent space 10.

The criteria relating to the ICAO standard comprise a facial pose, a facial expression, an image background, opening of a mouth or an eye, a gaze orientation, a position of an accessory such as glasses, illumination of the face.

With regard to the criterion relating to the opening of the mouth, the mouth has to be in the closed position to be compliant with the ICAO standard.

For example, the image of an individual represented in the latent space 10 by the initial data point 140 comprises a face with a mouth in the open position.

One displacement or multiple successive displacements in the latent space 10 make it possible to generate a modified image representing the face of the individual with the mouth in the closed position, while preserving the biometric identity of the individual.

Depending on the displacement, the physical characteristics of the individual may also be preserved.

For example, the modified image represented in the latent space 10 by the final data point 144 is a final image that comprises the face of the individual with a mouth in the closed position, the biometric identity of the individual being preserved.

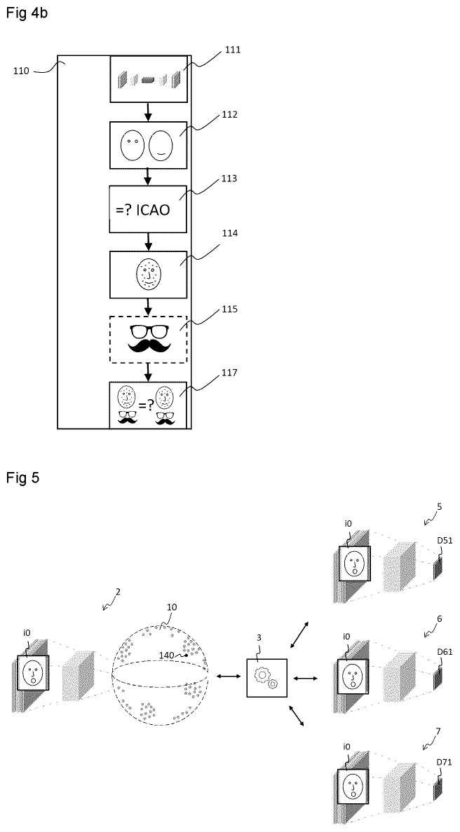

FIGS. 4a and 4b illustrate the steps of the method of the invention that are intended to be implemented by a computer.

The method of the invention is a method for making an image of an individual i0 compliant with a standard, and comprises a first extraction step 100, a first determination step 101, an optional first characterization step 102, a processing step 110 and a validation step 120.

The image of the individual i0 is referred to as an intermediate image because it is not compliant with the standard and has to be modified to make it compliant with said standard.

In the first extraction step 100, the computer extracts first biometric data of the individual from the image of the individual i0.

For example, the extraction is carried out by way of an analyzer for analyzing distances and proportions between characteristic points of the face. The first biometric data comprise distance and proportion data.

For example, the extraction is carried out by way of an analyzer for analyzing elements of a face. The first biometric data comprise characteristic data associated with the eyes, the nose, the lips, the ears, the chin.

For example, the extraction is carried out by way of an analyzer for analyzing particular points of a face. The first biometric data comprise data characterizing predetermined points.

For example, the extraction is carried out using a neural network. The first data comprise a data vector.

In the first determination step 101, the computer determines first data relating to the standard based on the image of the individual i0.

The first data relating to the standard may be determined by an algorithm, an image analyzer or a neural network.

For example, the first data relating to the standard comprise, for each criterion relating to the standard, a datum representing compliance or non-compliance with the standard.

For example, for a mouth opening criterion, the open position is associated with a first value of a first datum, and the closed position is associated with a second value of the first datum.

For example, for a face illumination position criterion, illumination compliant with the standard is associated with a first value of a second datum, and illumination not compliant with the standard is associated with a second value of the second datum.

For example, for an image background criterion, a neutral background is associated with a first value of a third datum, and a non-neutral background is associated with a second value of the third datum.

According to one variant embodiment, the method comprises a first characterization step 102.

In the first characterization step 102, the computer generates first data relating to physical attributes based on the image of the individual i0.

The physical attributes comprise accessories and/or personal attributes.

Among accessories, mention may be made of examples such as glasses, a sanitary mask, a scarf, a hair slide, earrings, a headband, etc.

Among personal attributes, mention may be made of examples such as a mustache, a beard, a mark on the skin, a hairstyle, a hair texture, a hair color, an age, a gender.

The first data relating to physical attributes may be generated by an algorithm, an image analyzer or a neural network.

For example, the first data relating to physical attributes comprise a datum representative of the presence or absence of glasses and optionally of the shape and/or color thereof.

For example, the first data relating to physical attributes comprise a datum representative of the presence or absence of a beard and/or mustache and optionally of the shape and/or color thereof.

For example, the first data relating to physical attributes comprise a datum representative of the presence, location, color and/or shape of a mark on the skin.

The processing step 110 comprises a modification step 111, a second determination step 112, a second extraction step 114, an optional second characterization step 115 and a verification step 117.

In the modification step 111, the computer modifies the intermediate image into a modified image by way of the generative adversarial network 1, on the basis of the first biometric data of the individual and of the first data relating to the standard.

When the modification step 111 is implemented for the first time with a view to making the image of the individual i0 compliant, the intermediate image is the image of the individual i0.

As illustrated in FIGS. 2 and 3, the latent space 10 of the generative adversarial network 1 comprises a plurality of data points 140, 141-143.

The intermediate image corresponds to a data point 140 in the latent space.

The position of a data point 140, 141-143 in the latent space 10 is a function of biometric and physical characteristics of the individual and of characteristics relating to the standard.

Thus, on the basis of the first biometric data representative of biometric characteristics of the individual and of the first data relating to the standard and representative of characteristics relating to the standard, a displacement within the latent space 10 in a direction that tends to modify the characteristics relating to the standard while preserving the biometric characteristics of the individual makes it possible to modify the intermediate image into a modified image with a view to making the intermediate image compliant with the standard, without modifying the identity of the individual.

In addition, on the basis of the first data relating to physical attributes representative of physical characteristics of the individual, a displacement within the latent space 10 in a direction that tends to modify the characteristics relating to the standard while preserving the physical characteristics of the individual makes it possible to modify the intermediate image into a modified image with a view to making said intermediate image compliant with the standard, without modifying said physical attributes of the individual.

The first data relating to the standard determined by the computer based on the image of the individual i0 are representative of initial characteristics relating to the standard. On the basis of the first data relating to the standard, the computer determines target characteristics relating to the standard to be achieved in the displacement in the latent space 10, the target characteristics relating to the standard being compliant with the standard and therefore being different from the initial characteristics relating to the standard.

For example, the first data relating to the standard comprise a datum representing non-compliance with the standard for a mouth opening criterion. The target characteristics relating to the standard comprise characteristics compliant with the standard and corresponding to a closed mouth position.

For example, the first data relating to the standard comprise a datum representing non-compliance with the standard for an image background criterion. The target characteristics relating to the standard comprise characteristics compliant with the standard and corresponding to a neutral image background.

The first biometric data determined by the computer based on the image of the individual i0 are representative of initial biometric characteristics of the individual. The computer determines target biometric characteristics to be achieved in the displacement in the latent space 10, the target biometric characteristics being identical to the initial biometric characteristics.

The first data relating to physical attributes generated by the computer based on the image of the individual i0 are representative of initial physical characteristics of the individual. The computer determines target physical characteristics to be achieved in the displacement in the latent space 10, the target physical characteristics being identical to the initial physical characteristics.

The displacement in the latent space 10 is such that the computer minimizes a deviation between current parameters comprising the biometric characteristics and the characteristics relating to the standard corresponding to the data point associated with the intermediate image, and target parameters comprising the target biometric characteristics and the target characteristics relating to the standard.

According to the variant embodiment, the computer possesses first data relating to physical attributes resulting from the first characterization step 102 and the current parameters furthermore comprise the physical characteristics corresponding to the data point associated with the intermediate image and the target parameters furthermore comprise the target physical characteristics.

Multiple displacements may be necessary to achieve compliance with the standard, then requiring multiple iterations of the modification step 111.

It is thus necessary, after each implementation of the modification step 111, to verify that the modified image is compliant with the standard.

In the second determination step 112, the computer determines second data relating to the standard, based on the modified image.

The computer determines the second data relating to the standard in the same way and using the same method for which it determines the first data relating to the standard, the difference being that the computer does so based on the modified image rather than doing so based on the image of the individual i0.

In the checking step 113, the computer checks whether the modified image is compliant with the standard based on the second data relating to the standard.

The modified image is determined to be compliant if it is compliant with the standard.

The modified image is determined to be non-compliant if it is not compliant with the standard.

It is also necessary, after each implementation of the modification step 111, to verify that the identity of the individual has not been altered by the displacement within the latent space 10.

For example, a displacement in the latent space 10 to a neighboring data cluster alters the identity of the individual.

The displacement in the latent space 10 is carried out as a function of target parameters comprising multiple characteristics. It is thus possible, over one implementation of the modification step 111, to move certain characteristics away from their target, in favor of bringing another characteristic closer to its target.

In the second extraction step 114, the computer extracts second biometric data of the individual from the modified image.

The computer extracts the second biometric data in the same way and using the same method for which it determines the first biometric data, the difference being that the computer does so based on the modified image rather than doing so based on the image of the individual i0.

In the verification step 117, the computer verifies the integrity of the biometric identity in the modified image by comparing the first biometric data with the second biometric data.

For example, if the second biometric data are identical to the first biometric data, the biometric identity exhibits integrity.

Since the first biometric data and the second biometric data were generated in the same way and using the same method, it is easy to compare the data in order to verify that the biometric identity has not been altered.

According to the variant embodiment, the processing step 110 comprises the second characterization step 115 ahead of the verification step 117.

In the second characterization step 115, the computer generates second data relating to physical attributes based on the modified image.

The computer extracts the second data relating to physical attributes in the same way and using the same method for which it determines the first data relating to physical attributes, the difference being that the computer does so based on the modified image rather than doing so based on the image of the individual i0.

According to the variant embodiment, the verification step 117 furthermore comprises verifying the integrity of the physical attributes by comparing the first data relating to the physical attributes with the second data relating to the physical attributes. The computer thus verifies the integrity both of the biometric identity and of the physical attributes.

For example, if the second data relating to the physical attributes are identical to the first data relating to the physical attributes, the physical attributes exhibit integrity.

Following the processing step 110, it is possible to distinguish between two cases.

In a first case, the biometric identity exhibits integrity and the modified image is determined to be compliant and, in the case of the variant embodiment, the physical attributes also exhibit integrity. Then, in the validation step 120, the computer validates the modified image, and the modified image is a final image iF.

Otherwise, and this corresponds to the second case, the processing step 110 is reiterated with the modified image from the previous iteration as intermediate image.

It should be recalled that, in the first implementation of the modification step 111, the intermediate image is the image of the individual i0. In following iterations, the intermediate image is a modified image, and in particular the modified image from the previous iteration.

In the first case, the desired aim is achieved. The final image iF is a modified image of the image of the individual i0. The final image iF is compliant with the standard and the biometric identity of the image of the individual is preserved.

Furthermore, according to the variant embodiment, it is also guaranteed that the physical attributes exhibit integrity. The final image iF is a modified image of the image of the individual, compliant with the standard and the biometric identity and physical characteristics of which exhibit integrity. For example, if the individual has a beard in the image of the individual i0, the beard is still present in the final image iF.

In the second case, the intermediate image is still not compliant with the standard or else the identity of the individual has been modified, it is necessary to modify the intermediate image again and therefore to reiterate the processing step 110.

Furthermore, according to the variant embodiment, it is not acceptable to alter the physical attributes, the intermediate image has to be modified and the processing step 110 has to be reiterated. For example, if the individual has a beard in the image of the individual i0 and the beard is no longer present in the modified image, the method for achieving compliance with the standard is continued, even if the biometric identity exhibits integrity and the modified image is compliant with the standard.

Thus, by way of multiple iterations of the processing step 110, the intermediate image is modified by small displacements in the latent space 10 of the generative adversarial network 1.

For example, the processing step 110 is reiterated as many times as necessary to achieve the first case whereby the computer validates the modified image in the validation step 120, the modified image being a final image iF.

For example, the processing step 110 is reiterated a maximum number of times. If, at the end of this number of iterations, the intermediate image does not meet the requirements of the first case, the computer invalidates the modified image and does not generate a final image iF.

FIGS. 5, 6, 7 and 8 illustrate a neural system comprising:
a computer 3,
the assembly from FIG. 1 comprising the neural network 2 and the generative adversarial network 1 comprising the latent space 10,
a biometric neural network 5 able to generate biometric data based on an image,
a first predictive neural network 6 able to generate the data relating to the standard based on an image,
a second predictive neural network 7 able to generate data relating to physical attributes based on an image.

This neural system enables the computer 3 to implement the steps of the method of the invention and as described below.

As illustrated in FIG. 5, the computer 3 generates, based on the image of an individual i0:
the first biometric data of the individual D51, by way of the biometric neural network 5, in the first extraction step 100,
the first data relating to the standard D61, by way of the first predictive neural network 6, in the first determination step 101,
first data relating to physical attributes D71, by way of the second predictive neural network 7, in the first characterization step 102.

The first biometric data of the individual D51 and the first data relating to physical attributes D71 are representative of initial biometric and physical characteristics of the individual that should not be modified in the generated final image with a view to compliance.

The computer 3 thus determines, for target biometric and physical characteristics, the initial biometric and physical characteristics, which are associated, as already mentioned, with the first biometric data of the individual D51 and with the first data relating to physical attributes D71.

The first data relating to the standard D61 correspond to initial characteristics relating to the standard, some being compliant with the standard and not needing to be modified in the final image, others not being compliant with the standard and needing to be modified in the final image.

The computer 3 thus determines target characteristics relating to the standard, which are compliant with the standard and are different from the initial characteristics relating to the standard. The target characteristics correspond to target data relating to the standard and associated with the first predictive neural network 6.

The target data represent the set of target data relating to the standard, first biometric data of the individual D51 and first data relating to physical attributes D71.

The image of the individual i0 is represented by the initial data point 140 generated by the neural network 2, in the latent space 10 of the generative adversarial network 1.

The image of the individual i0 is the intermediate image intended to be modified by the modification step 111.

Prior to the modification step 111, the computer 3 determines current data.

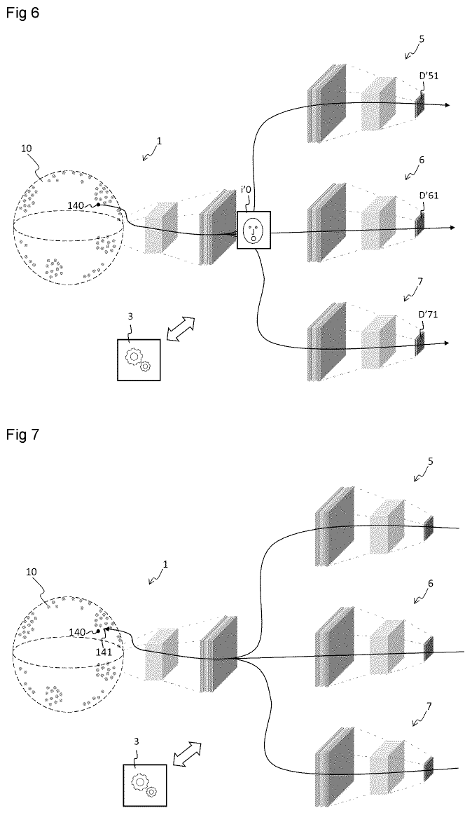

As shown in FIG. 6, based on the initial data point 140, the generative adversarial network 1 generates an adjusted image of the individual i′0, which may be slightly different from the image of the individual i0.

Based on this adjusted image of the individual i′0, the computer 3 generates a set of three adjusted first data:
adjusted first biometric data of the individual D′51, by way of the biometric neural network 5,
adjusted first data relating to the standard D′61, by way of the first predictive neural network 6,
adjusted first data relating to physical attributes D′71, by way of the second predictive neural network 7.

The set of adjusted data corresponds to current data.

To generate the modified image in the modification step 111, the computer 3 computes a distance between the current data and the target data and then determines a displacement in the latent space 10 to an intermediate data point 141 that minimizes this distance by backpropagation in the neural assembly, as shown in FIG. 7.

The displacement thus determined minimizes a deviation between common parameters comprising the biometric and physical characteristics and the characteristics relating to the standard corresponding to the data point associated with the intermediate image (here, the image of the individual i0 or, more precisely, the adjusted image of the individual i′0 derived from the image of the individual i0), and the target parameters comprising the target characteristics.

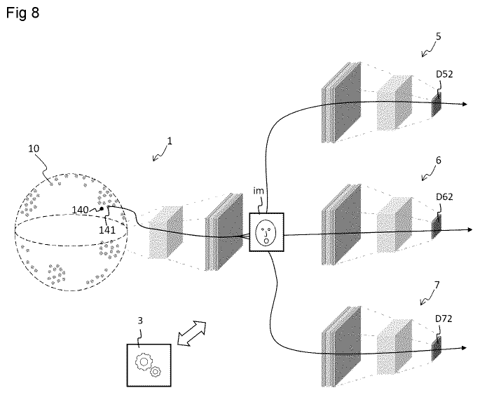

FIG. 8 illustrates the generation of the modified image im based on the intermediate data point 141, by way of the generative adversarial network 1.

Once the modified image im has been generated, the computer 3 then generates, based on the modified image im:
the second biometric data of the individual D52, in the second extraction step 114,
the second data relating to the standard D62, by way of the first predictive neural network 6, in the second determination step 112,
second data relating to physical attributes D72, by way of the second predictive neural network 7, in the second characterization step 115.

The set of second data corresponds to the current data, replacing the previous current data that corresponded to the set of adjusted data.

The computer 3 checks whether the modified image im is compliant with the standard based on the second data relating to the standard D62, the modified image being determined to be compliant or non-compliant at the end of the check, in the checking step 113.

The computer 3 verifies the integrity of the biometric identity by comparing the first biometric data D51 with the second biometric data D52, and the integrity of the physical attributes by comparing the first data relating to the physical attributes D71 with the second data relating to the physical attributes D72, in the verification step 117.

If the biometric identity and the physical characteristics exhibit integrity and the modified image is compliant, then the modified image is the final image. The compliance method is complete.

Otherwise, the modified image is an intermediate image and the method continues in order to generate a new modified image by reiterating the modification step 111, second determination step 112, checking step 113, second extraction step 114 and verification step 117, as already described above.

Thus, to generate a new modified image in the modification step 111, the computer 3 computes a distance between the last current data and the target data and then determines a displacement in the latent space 10 to a new intermediate data point 142 that minimizes this distance by backpropagation in the neural assembly, in a manner similar to what is shown in FIG. 7.

Next, the computer 3 reiterates the execution of the second determination step 112, checking step 113, second extraction step 114 and verification step 117.

The modification step 111, second determination step 112, checking step 113, second extraction step 114 and verification step 117 are reiterated for example until obtaining a modified image im that is compliant with the standard and for which the biometric identity and the physical characteristics exhibit integrity. The modified image is then the final image. The compliance method is complete.

The advantage of a neural system-based solution is that it is possible for the computer 3 to predict the direction in which to carry out a displacement within the latent space, by backpropagation when minimizing the deviation between current parameters and the target parameters.

However, this solution is not limiting.

For example, the computer 3 may carry out a displacement in the latent space without knowing the direction to take and, through multiple iterations of the processing step 110, learn how to move there so as to make the image of an individual i0 compliant in accordance with the method of the invention.

1. A compliance method for making an image of an individual, being an intermediate image, compliant with a standard using a computer, the compliance method comprising:
extracting first biometric data of the individual from the image of the individual;
determining first data relating to the standard based on the image of the individual;
modifying the intermediate image into a modified image by way of a generative adversarial network;
second determining second data relating to the standard, based on the modified image;
checking the compliance of the modified image with the standard based on the second data relating to the standard, the modified image being determined to be compliant or non-compliant;
second extracting second biometric data of the individual from the modified image
verifying the integrity of the biometric identity by comparing the first biometric data with the second biometric data; and
validating the modified image if the biometric identity exhibits integrity and the modified image is determined to be compliant, the modified image being a final image, otherwise repeating the modifying, second determining, checking, second extracting, verifying and validating steps with the modified image from a previous iteration as intermediate image.

2. The compliance method as claimed in claim 1, further comprising generating first data relating to physical attributes based on the image of the individual, and second generating second data relating to physical attributes based on the modified image,
wherein the verifying step further comprises verifying an integrity of the physical attributes by comparing the first data relating to the physical attributes with the second data relating to the physical attributes, the modified image being validated if the physical attributes also exhibit integrity, otherwise repeating the modifying, second determining, checking, second extracting, verifying and validating steps.

3. The compliance method as claimed in claim 2, wherein the image of the individual includes a face, the physical attributes including accessories including glasses, a sanitary mask, and personal attributes including a mustache, a beard, a mark on skin, a characteristic relating to hair, an age, and a gender.

4. The compliance method as claimed in claim 1, wherein the generative adversarial network including a latent space containing a plurality of data points, each data point being associated with an image, the intermediate image being represented by a data point whose position in the latent space is a function of biometric and physical characteristics of the individual and of characteristics relating to the standard, the intermediate image being modified by a displacement in the latent space as a function of the first biometric data of the individual and the first data relating to the standard.

5. The compliance method as claimed in claim 4, wherein the displacement minimized a deviation between current parameters having the biometric characteristics and the characteristics relating to the standard corresponding to the data point associated with the intermediate image, and target parameters having target biometric characteristics corresponding to the first biometric data and target characteristics relating to the standard and compliant with the standard.

6. The compliance method as claimed in the preceding claim 5, wherein the current parameters further comprise the physical characteristics corresponding to the data point associated with the intermediate image and the target parameters further comprise target physical characteristics corresponding to the first data relating to the physical attributes.

7. The compliance method as claimed in claim 1, wherein the image of the individual includes a face of said individual, the standard relating to identity photographs intended to be affixed to identity documents, as specified by ICAO.

8. The compliance method as claimed in claim 7, wherein the standard includes at least one criterion from among: a facial pose, a facial expression, an image background, opening of a mouth or an eye, a gaze orientation, a position of an accessory including glasses, and illumination of the face.

9. A non-transitory computer readable medium having stored thereon program instructions that when executed by a computer causes the computer to implement the compliance method as claimed in claim 1.

10. A device comprising:
a computer having a processor; and
a neural network having a generative adversarial network,
wherein the processor is configured to make an image of an individual, being an intermediate image, compliant with a standard by the processor being configured to:
extract first biometric data of the individual from the image of the individual;
determine first data relating to the standard based on the image of the individual;
modify the intermediate image into a modified image by way of a generative adversarial network;
second determine second data relating to the standard, based on the modified image;
check compliance of the modified image with the standard based on the second data relating to the standard, the modified image being determined to be compliant or non-compliant;
second extract second biometric data of the individual from the modified image
verify an integrity of a biometric identity by comparing the first biometric data with the second biometric data; and
validate the modified image if the biometric identity exhibits integrity and the modified image is determined to be compliant, the modified image being a final image, otherwise is processor is further configured to repeat the processor being configured to modify, second determine, check, second extract, verify and validate with the modified image from a previous iteration as intermediate image.

11. The compliance method as claimed in claim 2, wherein the generative adversarial network including a latent space containing a plurality of data points, each data point being associated with an image, the intermediate image being represented by a data point whose position in the latent space is a function of biometric and physical characteristics of the individual and of characteristics relating to the standard, the intermediate image being modified by a displacement in the latent space as a function of the first biometric data of the individual and the first data relating to the standard.

12. The compliance method as claimed in claim 3, wherein the generative adversarial network including a latent space containing a plurality of data points, each data point being associated with an image, the intermediate image being represented by a data point whose position in the latent space is a function of biometric and physical characteristics of the individual and of characteristics relating to the standard, the intermediate image being modified by a displacement in the latent space as a function of the first biometric data of the individual and the first data relating to the standard.

13. The compliance method as claimed in claim 2, wherein the image of the individual includes a face of said individual, the standard relating to identity photographs intended to be affixed to identity documents, as specified by ICAO.

14. The compliance method as claimed in claim 3, wherein the image of the individual includes a face of said individual, the standard relating to identity photographs intended to be affixed to identity documents, as specified by ICAO.

15. The compliance method as claimed in claim 4, wherein the image of the individual includes a face of said individual, the standard relating to identity photographs intended to be affixed to identity documents, as specified by ICAO.

16. The compliance method as claimed in claim 5, wherein the image of the individual includes a face of said individual, the standard relating to identity photographs intended to be affixed to identity documents, as specified by ICAO.

17. The compliance method as claimed in claim 6, wherein the image of the individual includes a face of said individual, the standard relating to identity photographs intended to be affixed to identity documents, as specified by ICAO.
